(19) United States
(12) Patent Application Publication
(10) Pub. No.: US 2026/0039507 A1
(43) Pub. Date: Feb. 5, 2026

(54) DATA TRANSMISSION METHOD BASED ON CLOUD NETWORK, DEVICE AND MEDIUM

(71) Applicant: Beijing Volcano Engine Technology Co., Ltd., Haidian District (CN)

(72) Inventors: Daxiang KANG, Beijing (CN); Di FANG, Beijing (CN)

(21) Appl. No.: 19/180,884

(22) Filed: Apr. 16, 2025

(30) Foreign Application Priority Data
Jul. 31, 2024 (CN) 202411045703.6

(51) Int. Cl. H04L 12/46; H04L 67/10

(52) U.S. Cl. CPC H04L 12/4641; H04L 67/10

(57) ABSTRACT

A data transmission method based on a cloud network, a device, and a medium are provided. The method includes: receiving a first data flow transmitted through a first elastic network interface in an elastic network interface pair connected to a first cloud server, in which the elastic network interface pair includes the first elastic network interface and a second elastic network interface, and the first elastic network interface is configured to transmit a data flow to a second cloud server through the second elastic network interface connected to the second cloud server; and when it is determined that the first data flow is transmitted through the elastic network interface pair, querying an address of the second elastic network interface in a fast channel, and forwarding the first data flow to the second cloud server based on the address of the second elastic network interface.

### CROSS-REFERENCE TO RELATED APPLICATION

This application claims priority to Chinese Patent Application No. 202411045703.6 filed on Jul. 31, 2024, the disclosure of which is incorporated herein by reference in its entirety as part of this application.

### TECHNICAL FIELD

The present disclosure relates to the field of communication technologies, and in particular, to a data transmission method and apparatus based on a cloud network, a device, and a medium.

### BACKGROUND

A virtual private cloud (VPC) constructs an isolated virtual network environment that is configured and managed by a user for an elastic cloud server, to improve security of resources of the user in the cloud and simplify network deployment of the user. Currently, interconnection between two devices in the cloud is generally implemented by using a VPC route. Specifically, if the two devices need to communicate with each other, a tunnel may be established between the two devices based on a VPC network, and then data transmission is performed based on a configured VPC route. This implementation is complex, and all functions provided by the VPC need to be performed during data transmission. However, some other functions are not essential to data transmission, affecting data forwarding performance.

### SUMMARY

In view of this, embodiments of the present disclosure provide a data transmission method and apparatus based on a cloud network, a device, and a medium, to simplify implementation of interconnection between devices in the cloud and improve data transmission performance.

To solve the above problem, the embodiments of the present disclosure provide the following technical solutions.

According to a first aspect, the embodiments of the present disclosure provide a data transmission method based on a cloud network. The method includes:
receiving a first data flow transmitted through a first elastic network interface in an clastic network interface pair connected to a first cloud server, in which the elastic network interface pair includes the first clastic network interface and a second elastic network interface, the first elastic network interface is connected to the first cloud server, and the first elastic network interface is configured to transmit a data flow to the second cloud server through the second elastic network interface connected to the second cloud server, in which the elastic network interface pair is independently deployed in a subnet in the cloud network; and
when it is determined that the first data flow is transmitted through the elastic network interface pair, querying an address of the second elastic network interface in a fast channel, and forwarding the first data flow to the second cloud server based on the address of the second elastic network interface.

According to a second aspect, the embodiments of the present disclosure provide a data transmission apparatus based on a cloud network. The apparatus includes:
a receiving unit, configured to receive a first data flow transmitted through a first elastic network interface in an elastic network interface pair connected to a first cloud server, in which the elastic network interface pair includes the first elastic network interface and a second elastic network interface, the first elastic network interface is connected to the first cloud server, and the first elastic network interface is configured to transmit a data flow to a second cloud server through the second elastic network interface connected to the second cloud server, in which the elastic network interface pair is independently deployed in a subnet in the cloud network;
a querying unit, configured to, when it is determined that the first data flow is transmitted through the elastic network interface pair, query an address of the second elastic network interface in a fast channel; and
a forwarding unit, configured to forward the first data flow to the second cloud server based on the address of the second elastic network interface.

According to a third aspect, the embodiments of the present disclosure provide a data transmission device based on a cloud network. The device includes a memory, a processor, and a computer program stored in the memory and capable of running on the processor. When the computer program is executed by the processor, the data transmission method based on a cloud network is implemented.

According to a fourth aspect, the embodiments of the present disclosure provide a computer-readable storage medium. The computer-readable storage medium stores instructions. When the instructions are run on a terminal device, the terminal device is enabled to perform the data transmission method based on a cloud network.

### BRIEF DESCRIPTION OF DRAWINGS

FIG. 1 is a schematic diagram of an exemplary application scenario in the related art.

FIG. 2 is a schematic diagram of an exemplary implementation in the related art.

FIG. 3 is a schematic diagram of an exemplary application scenario according to embodiments of the present disclosure.

FIG. 4 is a flowchart of a data transmission method based on a cloud network according to embodiments of the present disclosure.

FIG. 5 is a schematic diagram of an exemplary implementation according to embodiments of the present disclosure.

FIG. 6(a) is a schematic diagram of a connection manner of an elastic network interface pair according to embodiments of the present disclosure.

FIG. 6(b) is a schematic diagram of another connection manner of an elastic network interface pair according to embodiments of the present disclosure.

FIG. 6(c) is a schematic diagram of a connection manner of an elastic network interface pair according to embodiments of the present disclosure.

FIG. 7 is a schematic diagram of a data forwarding apparatus according to embodiments of the present disclosure.

FIG. 8 is a schematic diagram of an electronic device according to embodiments of the present disclosure.

### DETAILED DESCRIPTION

To make the foregoing objectives, features, and advantages of the embodiments of the present disclosure more comprehensible, the following further describes the embodiments of the present disclosure in detail with reference to the drawings and specific implementations.

To facilitate understanding and explanation of the technical solutions provided in the embodiments of the present disclosure, background art of the embodiments of the present disclosure is described below.

Currently, interconnection between two devices in the cloud is generally implemented by using a VPC route. The devices in the cloud may be, for example, a router, a load balancer, network address translation (NAT), a firewall, or other network elements. A network element based on a VPC is generally implemented by an elastic compute service (ECS) (also referred to as a cloud server). An ECS may be understood as a virtual machine, and needs to run on a physical machine. In other words, interconnection between the devices in the cloud is a communication process between ECSs in practical application.

Referring to FIG. 1, which shows a diagram of a scenario example in the related art. The network element 1 provides a capability of communicating with a private network outside the cloud for the devices in the VPC1 and the VPC2. The network element 1 constitutes a transit router (TR). The network element 1 belongs to the service VPC1. The network element 2 may be a router used by a third-party software-defined wide area network (SDWAN) vendor for multi-cloud interconnection. The network element 2 belongs to the service VPC2. When a data package from the VPC1 and the VPC2 needs to be sent to an external network, the data package may be sent to the network element 2 by the network element 1, and then sent to the external network. When the network element 1 communicates with the network element 2, a VPC route needs to be configured. For example, an outbound routing table of the network element 1 is 192.168.100.0/24 peering tunnel, and an inbound routing table of the network element 1 is 192.168.1.0/24 VPC1 and 192.168.2.0/24 VPC2. An outbound routing table of the network element 2 is 192.168.100.0/24 extunnel, and an inbound routing table of the network element 2 is 192.168.1.0/24 TR and 192.168.2.0/24 TR.

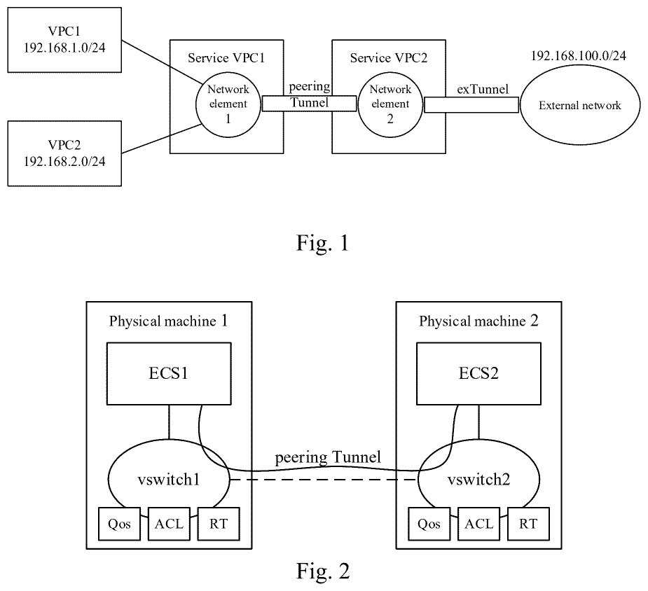

Establishment of a peering tunnel between the network element 1 and the network clement 2 is performed based on a VPC network. A VPC network function includes a quality of service (QOS) strategy of an elastic network interface (ENI), a security group access control list (ACL), and a route (TR) of a VPC. Referring to FIG. 2, which shows a diagram of an implementation example in the related art. Based on the scenario shown in FIG. 2, at an implementation level, the network element 1 is implemented by an ECS1. The ECS1 runs on a physical machine 1. The network element 2 is implemented by an ECS2. The ECS2 runs on a physical machine 2. When a data package is sent from the network element 1 to the network element 2, traffic of the peering tunnel passes through a forwarding component vswitch1 that provides a VPC function on the physical machine 1 where the ECS1 is located.

In the implementation of the related art, data forwarding needs to be implemented based on a VPC route, and the route configuration is relatively complex. In addition, traffic needs to pass through all functions on the VPC forwarding component vswitch, but some of the functions are not essential to data forwarding, these functions form performance consumption and affect data forwarding performance. In addition, data forwarding is performed based on a tunnel, and the tunnel may bring elephant flow. Therefore, a capability of a single flow needs to be limited, thereby causing a performance bottleneck.

Based on this, the embodiments of the present disclosure provide a data transmission method and apparatus based on a cloud network, and a device. A new device interconnection technology in the cloud is provided. Two cloud servers ECSs are connected by using an elastic network interface pair (ENI pair), and communication between the ECSs is performed based on an address of an elastic network interface in the elastic network interface pair.

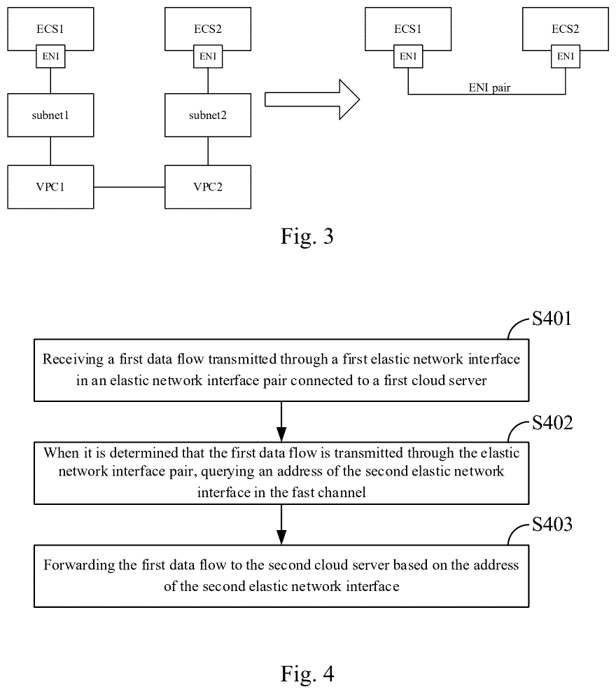

To facilitate understanding of the data transmission method for a cloud network provided in the embodiments of the present disclosure, the following describes the method with reference to a scenario example shown in FIG. 3. FIG. 3 is a schematic diagram of an exemplary application scenario according to the embodiments of the present disclosure.

FIG. 3 shows a schematic diagram of a connection of a common cloud server ECS on the left. The ENI of the common ECS has only one media access control (mac) address and belongs to one ECS. ENIs of the two ECSs belong to respective subnets and a VPC. Therefore, communication between the two ECSs needs to be performed based on a VPC route, and all functions of the VPC need to be performed.

FIG. 3 shows an elastic network interface pair (ENI pair) provided in the embodiments of the present disclosure on the right. The ENI pair may be separately created and mounted on the two ECSs. The ENI pair has two mac addresses and does not belong to any subnet or VPC, thereby greatly simplifying address planning complexity of a user for managing ECS interconnection.

In the embodiments of the present disclosure, ECS interconnection may also apply to a data transmission scenario between ECSs of the source address and the destination address of all non-data package.

It may be understood by a person skilled in the art that the schematic diagram of the framework shown in FIG. 3 is merely an example in which the implementations of the present disclosure may be implemented. The scope of applicability of the implementations of the present disclosure is not limited in any aspect of the framework.

To facilitate understanding of the embodiments of the present disclosure, the following describes a data transmission method based on a cloud network according to the embodiments of the present disclosure with reference to the drawings.

Referring to FIG. 4, which is a flowchart of a data transmission method based on a cloud network according to the embodiments of the present disclosure. As shown in FIG. 4, the method may include S401 to S403.

S401, receiving a first data flow transmitted through a first elastic network interface in an elastic network interface pair connected to a first cloud server.

The elastic network interface pair includes the first elastic network interface and a second elastic network interface. The first elastic network interface is connected to the first cloud server, and the first elastic network interface is configured to transmit a data flow to a second cloud server through the second elastic network interface connected to the second cloud server. The clastic network interface pair is independently deployed in a subnet in the cloud network.

In the embodiments of the present disclosure, when the first cloud server and the second cloud server need to be interconnected, a management and control module in the cloud may create an elastic network interface pair (ENI pair). The ENI pair is configured with two elastic network interfaces (ENIs), that is, the first elastic network interface and the second elastic network interface. Two mac addresses are allocated to the ENI pair. The ENIs at two ends of the ENI pair each have one mac address. The ENI pair is mounted on the first cloud server and the second cloud server. The first elastic network interface is used as an ENI used by the first cloud server, and the second elastic network interface is used as an ENI used by the second cloud server. The first cloud server and the second cloud server cach run on a physical machine. The ENI pair is independently deployed in the cloud network and does not belong to a VPC, that is, a non-VPC ENI peer connection manner is provided.

Then, the management and control module may obtain the address of the first elastic network interface and the address of the second elastic network interface, attach the address of the first elastic network interface and the address of the second elastic network interface to the data structure of the ENI pair, and deliver the addresses to the physical machines at two ends.

In addition, an Internet Protocol (IP) address of the ENI pair may be allocated by the ECS, that is, the first cloud server allocates an IP address to the first elastic network interface, and the second cloud server allocates an IP address to the second elastic network interface. The ECS may specify, through the IP address, that the ENI pair is used for communication. In practical applications, 169.254 or another IP address with a non-service planned/31 mask may be used for IPV4, and a common device interconnection address may be used for IPV6.

The data transmission method based on a cloud network is described in the embodiments of the present disclosure from the perspective of the physical machine where the first cloud server is located. When the first cloud server sends the first data flow to the second cloud server, the first data flow may be obtained through the first elastic network interface in the ENI pair.

In a possible implementation, the method may further include:
after the elastic network interface pair is connected to the first cloud server and the second cloud server, obtaining the address of the first elastic network interface and the address of the second elastic network interface; and saving the address of the first elastic network interface and the address of the second elastic network interface in the fast channel.

In practical applications, after the management and control module delivers the address of the first elastic network interface and the address of the second elastic network interface, the physical machine where the first cloud server is located may obtain and save the address of the first elastic network interface and the address of the second elastic network interface. Specifically, the address of the first elastic network interface and the address of the second elastic network interface may be saved in the fast channel of the first forwarding component in the physical machine where the first cloud server is located.

The address of the first elastic network interface may be configured as a physical machine address of the physical machine where the first cloud server is located. The address of the second elastic network interface may be configured as a physical machine address of the physical machine where the second cloud server is located.

S402, when it is determined that the first data flow is transmitted through the elastic network interface pair, querying an address of the second elastic network interface in the fast channel.

In practical applications, the fast channel fastpath of the first forwarding component saves the data structure of the ENI pair, the data structure includes the address of the first elastic network interface and the address of the second elastic network interface. When it is determined, based on the ENI type, that the first data flow is sent through the ENI pair, the address of the second elastic network interface is queried in the fastpath, to obtain the physical machine address of the physical machine where the second cloud server is located.

S403, forwarding the first data flow to the second cloud server based on the address of the second elastic network interface.

The first data flow is sent to the second cloud server based on the address of the second elastic network interface. In practical applications, the first data flow may be sent to the second forwarding component on the physical machine where the second cloud server is located, and the second forwarding component sends the first data flow to the second cloud server.

In the embodiments of the present disclosure, the elastic network interface pair includes the first elastic network interface and the second elastic network interface. The first elastic network interface is connected to the first cloud server, and the second elastic network interface is connected to the second cloud server. The elastic network interface pair is independently deployed in the subnet in the cloud network, that is, the elastic network interface pair does not belong to any subnet or VPC. When the two cloud servers perform data transmission, after receiving the first data flow that is transmitted through the first elastic network interface, the address of the second elastic network interface is queried in the fast channel, and the first data flow is forwarded to the second cloud server based on the address of the second elastic network interface. Communication is performed based on the address of the second elastic network interface. This does not require a VPC route and is relatively simple to implement. In addition, because the elastic network interface pair does not belong to the VPC, not all functions of the VPC need to be performed during data transmission, and data transmission performance is improved.

In a possible implementation, the specific implementation in which the data package is sent to the second cloud server on the physical machine corresponding to the physical machine address in S403 may include the following.

A1: encapsulating the first data flow. An inner layer of the encapsulated first data flow carries a source address, a destination address, a source mac address, and a destination mac address, and an outer layer of the encapsulated first data flow carries a source physical machine address and a destination physical machine address. The source physical machine address is the address of the first elastic network interface, and the destination physical machine address is the address of the second elastic network interface. The source mac address and the destination mac address are mac addresses of the elastic network interface pair.

The first forwarding component encapsulates the data package. An inner layer of the encapsulated data package carries a source address src0, a destination address dst0, a source mac (media access control) address, and a destination mac address, and an outer layer of the encapsulated data package carries the address of the first elastic network interface and the address of the second elastic network interface. The source mac address and the destination mac address are mac addresses allocated to the ENI pair.

A2: Sending the encapsulated first data flow to the physical machine corresponding to the destination physical machine address, so that the physical machine corresponding to the destination physical machine address decapsulates the encapsulated first data flow, and sends the decapsulated first data flow to the second cloud server based on the destination mac address.

The encapsulated first data flow is sent to the second forwarding component on the physical machine corresponding to the destination physical machine address. The second forwarding component decapsulates the first data flow, and sends the first data flow to the second cloud server based on the destination mac address.

In a possible implementation, the data transmission method based on a cloud network provided in the embodiments of the present disclosure may further include: performing a corresponding quality of service (QOS) strategy for the first data flow.

The first forwarding component and the second forwarding component may further perform a corresponding QoS strategy, for example, limiting a speed of a data package sent through the ENI pair, or limiting a speed of a sent total data package. In this case, functions such as a security group of a forwarding component VPC and VPC route query may be skipped, and only a required QoS strategy is used, so that communication performance is fully improved while ensuring the quality of service.

In a possible implementation, the data transmission method based on a cloud network provided in the embodiments of the present disclosure may further include:
dynamically updating the address of the first elastic network interface or the address of the second elastic network interface in the elastic network interface pair based on a change of a physical machine connected to the elastic network interface pair.

In some scenarios, the physical machine where the first cloud server or the second cloud server is located may not be capable of providing a service. Therefore, the first cloud server or the second cloud server may be hot migrated to a new physical machine. When the physical machine changes, the management and control module in the cloud re-delivers the updated address of the first elastic network interface or the updated address of the second elastic network interface, and saves the updated address of the first elastic network interface or the updated address of the second elastic network interface to the data structure of the ENI pair. The first cloud server communicates with the second cloud server based on the updated address of the first elastic network interface or the updated address of the second elastic network interface, to implement hot migration of the ECS.

Similarly, when the second cloud server sends a second data flow to the first cloud server, the second forwarding component in the physical machine where the second cloud server is located may obtain the second data flow through the second elastic network interface in the ENI pair. When it is determined, based on the ENI type, that the second data flow is sent through the ENI pair, the fast channel of the second forwarding component is queried, to obtain the address of the first clastic network interface, that is, the physical machine address of the physical machine where the first cloud server is located. Then the second data flow is sent to the first forwarding component on the physical machine where the first cloud server is located based on the address of the first clastic network interface. The first forwarding component sends the second data flow to the first cloud server.

The embodiments of the present disclosure implement high-performance data forwarding based on an ENI pair, and support ECS-related functions such as QoS and hot migration, simplifying the implementation of ECS interconnection.

In practical applications, the physical machine where the first server is located includes the first forwarding component, and the physical machine where the second server is located includes the second forwarding component. The first forwarding component is connected to the first cloud server, and the second forwarding component is connected to the second cloud server.

The elastic network interface pair is further configured to perform communication between the first cloud server and the second cloud server based on the address of the first elastic network interface or the address of the second elastic network interface through the first forwarding component and the second forwarding component.

In other words, the first forwarding component is a component used for data forwarding in the physical machine where the first cloud server is located. The second forwarding component is a component used for data forwarding in the physical machine where the second cloud server is located. The first forwarding component and the second forwarding component constitute a path of the ENI pair.

The data structure of the ENI pair may be saved in the first forwarding component and the second forwarding component. Specifically, in addition to saving the address of the second elastic network interface at the peer end, the first forwarding component may further save the address of the first elastic network interface at the local end. In addition to saving the address of the first elastic network interface at the peer end, the second forwarding component may further save the address of the second elastic network interface at the local end.

When the first cloud server sends the first data flow to the second cloud server, the first forwarding component determines, based on the ENI type, that the first data flow is sent through the ENI pair, then queries the address of the second elastic network interface in the data structure of the ENI pair saved in the fast channel, and sends the first data flow to the second forwarding component. The second forwarding component sends the first data flow to the second cloud server.

Similarly, when the second cloud server sends the second data flow to the first cloud server, the second forwarding component determines, based on the ENI type, that the data package is sent through the ENI pair, then queries the address of the first elastic network interface in the data structure of the ENI pair saved in the fast channel, and sends the second data flow to the first forwarding component. The first forwarding component sends the second data flow to the first cloud server.

In this way, the ENI pair performs communication between the first cloud server and the second cloud server through the first forwarding component and the second forwarding component.

The data structure of the ENI pair is saved in the fast channel fastpath of the first forwarding component and the fast channel fastpath of the second forwarding component, so that the address of the first clastic network interface or the address of the second clastic network interface may be obtained more quickly without occupying forwarding resources of the slow channel slowpath of the first forwarding component and forwarding resources of the slow channel slowpath of the second forwarding component.

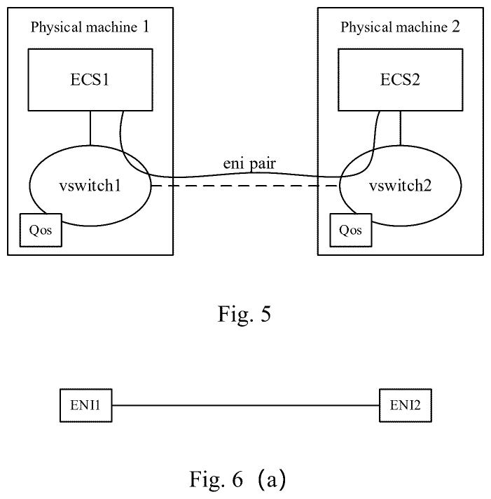

Referring to FIG. 5, which shows a schematic diagram of an exemplary implementation of a data transmission method based on a cloud network according to the embodiments of the present disclosure. In this example, the first cloud server ECS1 runs on the physical machine 1. The first forwarding component vswitchl is connected to the ECS1 and runs on the physical machine 1. The second cloud server ECS2 runs on the physical machine 2. The second forwarding component vswitch2 is connected to the ECS2 and runs on the physical machine 2. The ECS1 is connected to the ECS2 through the ENI pair. The management and control module delivers the mounting information of the ENI pair, that is, attaches the physical machine address of the physical machine 1 and the physical machine address of the physical machine 2 to the data structure of the ENI pair, and saves the addresses to the fastpath of the vswitch 1 and the fastpath of the vswitch2.

For example, when the first data flow is sent from the ECS1, the final destination address of the first data flow is dst0, and the source address is src0. The vswitch1 performs only resource limitation and management at the QoS level, for example, limiting the speed of the first data flow. The vswitch 1 determines, based on the ENI type, that the first data flow is sent through the ENI pair, and queries the physical machine address of the physical machine 2 based on the data structure of the ENI pair. The first data flow is encapsulated. An inner layer of the encapsulated data package carries the source address src0, the destination address dst0, the source mac address, and the destination mac address, and an outer layer of the encapsulated data package carries the address of the physical machine 1 and the address of the physical machine 2. The source mac address and the destination mac address are mac addresses allocated to the ENI pair. After the encapsulated data package is sent to the vswitch2, the data package is decapsulated and sent to the ECS2 based on the destination mac address, and the corresponding QoS strategy is performed.

In the communication process between the ECS1 and the ECS2 in the embodiments of the present disclosure, there is no requirement for VPC networking planning, no requirement for a VPC route and a security strategy, and no single-flow bottleneck problem caused by a tunnel.

Data forwarding performance can be optimized to the extreme, and the communication process can be used for interconnection between a plurality kinds of network elements.

In practical applications, the definition of an ENI pair may be extended. In a possible implementation, the first elastic network interface is connected to at least one first cloud server, and/or the second elastic network interface is connected to at least one second cloud server.

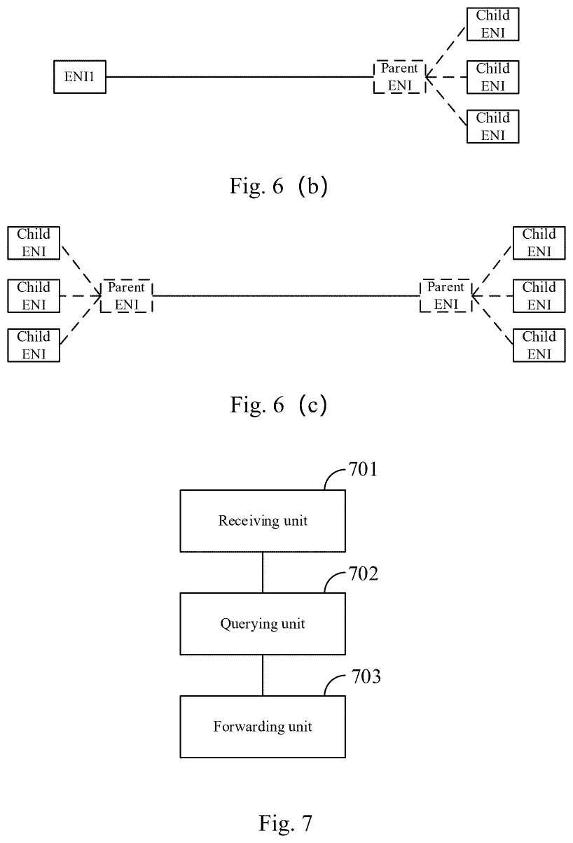

When the two ends of the ENI pair, that is, the first elastic network interface ENII and the second elastic network interface ENI2, are both connected to one ECS, a common ENI pair is formed. FIG. 6(a) shows a schematic diagram of such an ENI pair.

When one end of the ENI pair is a bondENI (parent ENI), and the bondENI includes a plurality of workENIs (child ENIs), the one end of the ENI pair may be connected to a plurality of ECSs. The plurality of ECSs provide a same service, to achieve high availability. The data flow may be sent to any one of the plurality of ECSs. FIG. 6(b) shows a schematic diagram of such an ENI pair. This is equivalent to an ENI pair formed by an ENI and a bondENI. For example, the first elastic network interface ENII may be connected to one ECS, and the second elastic network interface, as the bondENI (parent ENI), may include a plurality of workENIs (child ENIs), and each child ENI may be connected to one ECS.

When the two ends of the ENI pair are both bondENIs, and the bondENIs each include a plurality of workENIs, the two ends of the ENI pair may each be connected to a plurality of ECSs. FIG. 6(c) shows a schematic diagram of such an ENI pair. This is equivalent to an ENI pair formed by a bondENI and a bondENI. For example, the first elastic network interface, as the bondENI (parent ENI), may include a plurality of workENIs (child ENIs). Each child ENI may be connected to one ECS. The second elastic network interface, as the bondENI (parent ENI), may include a plurality of workENIs (child ENIs). Each child ENI may be connected to one ECS.

In the embodiments of the present disclosure, the ENI pair may be combined with technologies such as bondENI to implement high availability of the ECS.

Based on the data transmission method based on a cloud network provided in the foregoing method embodiments, the embodiments of the present disclosure further provide a data transmission apparatus based on a cloud network. The apparatus is described below with reference to the drawings.

Referring to FIG. 7, which is a schematic diagram of a structure of a data transmission apparatus based on a cloud network according to the embodiments of the present disclosure. As shown in FIG. 7, the data transmission apparatus based on a cloud network includes a receiving unit 701, a querying unit 702, and a forwarding unit 703.

The receiving unit 701 is configured to receive a first data flow transmitted through a first elastic network interface in an elastic network interface pair connected to a first cloud server. The elastic network interface pair includes the first elastic network interface and a second clastic network interface. The first elastic network interface is connected to the first cloud server, and the first elastic network interface is configured to transmit a data flow to a second cloud server through a second clastic network interface connected to the second cloud server. The elastic network interface pair is independently deployed in a subnet in the cloud network.

The querying unit 702 is configured to, when it is determined that the first data flow is transmitted through the elastic network interface pair, query an address of the second elastic network interface in a fast channel.

The forwarding unit 703 is configured to forward the first data flow to the second cloud server based on the address of the second elastic network interface.

In a possible implementation, the apparatus further includes an obtaining unit and a saving unit.

The obtaining unit is configured to, after the elastic network interface pair is connected to the first cloud server and the second cloud server, obtain an address of the first elastic network interface and the address of the second elastic network interface.

The saving unit is configured to save the address of the first elastic network interface and the address of the second elastic network interface in the fast channel. In a possible implementation, the apparatus further includes an updating unit.

The updating unit is configured to dynamically update the address of the first elastic network interface or the address of the second elastic network interface in the elastic network interface pair based on a change of a physical machine connected to the elastic network interface pair.

In a possible implementation, the address of the first elastic network interface is configured as a physical machine address of the physical machine where the first cloud server is located. The address of the second elastic network interface is configured as a physical machine address of the physical machine where the second cloud server is located.

In a possible implementation, the forwarding unit is further configured to:
encapsulate the first data flow, in which an inner layer of the encapsulated first data flow carries a source address, a destination address, a source media access control (mac) address, and a destination mac address, and an outer layer of the encapsulated first data flow carries a source physical machine address and a destination physical machine address; the source physical machine address is the address of the first elastic network interface, and the destination physical machine address is the address of the second elastic network interface; the source mac address and the destination mac address are mac addresses of the clastic network interface pair; and
send the encapsulated first data flow to the physical machine corresponding to the destination physical machine address, so that the physical machine corresponding to the destination physical machine address decapsulates the encapsulated first data flow, and sends the decapsulated first data flow to the second cloud server based on the destination mac address.

In a possible implementation, the first elastic network interface is connected to at least one first cloud server, and/or the second elastic network interface is connected to at least one second cloud server.

In a possible implementation, the apparatus further includes an execution unit.

The execution unit is configured to perform a corresponding quality of service strategy for the first data flow.

In addition, the embodiments of the present disclosure further provide a computer-readable storage medium. The computer-readable storage medium stores instructions. When the instructions are run on a terminal device, the terminal device is enabled to perform the data transmission method based on a cloud network according to any one of the above embodiments.

The embodiments of the present disclosure further provide a computer program product. The computer program product includes computer program instructions. When the computer program instructions are run on a computer, the computer is enabled to perform the data transmission method based on a cloud network according to any one of the above embodiments.

According to the data transmission method based on a cloud network provided in the foregoing method embodiments, the present disclosure further provides an electronic device. The electronic device includes one or more processors and a storage apparatus. The storage apparatus stores one or more programs. When the one or more programs are executed by the one or more processors, the one or more processors are enabled to implement the data transmission method based on a cloud network according to any one of the above embodiments.

In the embodiments of the present disclosure, the elastic network interface pair includes the first elastic network interface and the second elastic network interface. The first elastic network interface is connected to the first cloud server, and the second elastic network interface is connected to the second cloud server. The elastic network interface pair is independently deployed in the subnet in the cloud network, that is, the elastic network interface pair does not belong to any subnet or VPC. When the two cloud servers perform data transmission, after receiving the first data flow that is transmitted through the first elastic network interface, the address of the second elastic network interface is queried in the fast channel, and the first data flow is forwarded to the second cloud server based on the address of the second elastic network interface. Communication is performed based on the address of the second elastic network interface, this does not require a VPC route and is relatively simple to implement. In addition, because the elastic network interface pair does not belong to the VPC, not all functions of the VPC need to be performed during data transmission, and data transmission performance is improved.

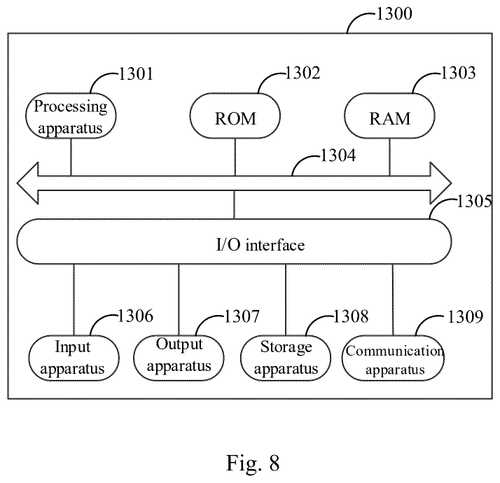

Referring to FIG. 8, FIG. 8 illustrates a schematic structural diagram of an electronic device 1300 suitable for implementing some embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital television (TV), a desktop computer, or the like. The electronic device illustrated in FIG. 8 is merely an example, and should not pose any limitation to the functions and the range of use of the embodiments of the present disclosure.

As illustrated in FIG. 8, the electronic device 1300 may include a processing apparatus 1301 (e.g., a central processing unit, a graphics processing unit, etc.), which can perform various suitable actions and processing according to a program stored in a read-only memory (ROM) 1302 or a program loaded from a storage apparatus 1308 into a random-access memory (RAM) 1303. The RAM 1303 further stores various programs and data required for operations of the electronic device 1300. The processing apparatus 1301, the ROM 1302, and the RAM 1303 are interconnected by means of a bus 1304. An input/output (I/O) interface 1305 is also connected to the bus 1304.

Usually, the following apparatus may be connected to the I/O interface 1305: an input apparatus 1306 including, for example, a touch screen, a touch pad, a keyboard, a mouse, a camera, a microphone, an accelerometer, a gyroscope, or the like; an output apparatus 1307 including, for example, a liquid crystal display (LCD), a loudspeaker, a vibrator, or the like; a storage apparatus 1308 including, for example, a magnetic tape, a hard disk, or the like; and a communication apparatus 1309. The communication apparatus 1309 may allow the electronic device 1300 to be in wireless or wired communication with other devices to exchange data. While FIG. 8 illustrates the electronic device 1300 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 1309 and installed, or may be installed from the storage apparatus 1308, or may be installed from the ROM 1302. When the computer program is executed by the processing apparatus 1301, the above-mentioned functions defined in the methods of some embodiments of the present disclosure are performed.

The electronic device provided in the embodiments of the present disclosure belongs to the same inventive concept as the data transmission method based on a cloud network provided in the above embodiments. For technical details not described in detail in this embodiment, reference may be made to the above embodiments. This embodiment and the above embodiments have the same beneficial effects.

According to the data transmission method based on a cloud network provided in the foregoing method embodiments, the embodiments of the present disclosure provides a computer-readable medium. The computer-readable medium stores a computer program. When the program is executed by a processor, the data transmission method based on a cloud network according to any one of the above embodiments is implemented.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to perform the above data transmission method based on a cloud network.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, cach block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, cach block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the embodiments of the present disclosure, the machine-readable medium may be a tangible medium that may include or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an crasable programmable read-only memory (EPROM or flash memory), an optical fiber, a portable compact disc read-only memory (CD-ROM), an optical storage device, a magnetic storage device, or any suitable combination thereof.

It should be noted that the various embodiments in the present disclosure are described in a progressive manner, with each embodiment focusing on the differences from other embodiments, and similar parts between the various embodiments may be referred to each other. For the systems or apparatuses disclosed in the embodiments, because they correspond to the methods disclosed in the embodiments, the description is relatively simple, and the relevant parts may refer to the description of the methods for details.

It should be understood that, in the present disclosure, “at least one (item)” refers to one or more, and “a plurality of” refers to two or more. “And/or” is used to describe the association relationship between associated objects, indicating that there may be three relationships. For example, “A and/or B” may indicate: only A exists, only B exists, and both A and B exist simultaneously, where A, B may be singular or plural. The character “/” generally indicates that the associated objects before and after are in a kind of “or” relationship. “At least one (item)” or similar expressions refer to any combination of these items, including any combination of single (item) or multiple (items). For example, at least one (item) of a, b, or c may indicate: a, b, c, “a and b”, “a and c”, “b and c”, or “a, b, and c”, where a, b, and c may be singular or plural.

It should be noted that in the present disclosure, relational terms such as “first,” “second,” etc. are only used to distinguish one entity or operation from another entity or operation, and do not necessarily require or imply the existence of any actual relationship or order between these entities or operations. Furthermore, the terms “comprise,” “comprising,” “include,” “including,” etc., or any other variant thereof are intended to cover non-exclusive inclusion, such that a process, method, article or device comprising a set of elements includes not only those elements, but also other elements not expressly listed, or other elements not expressly listed for the purpose of such a process, method, article or device, or elements that are inherent to such process, method, article or device. Without further limitation, an element defined by the phrase “includes a . . . ” does not preclude the existence of additional identical elements in the process, method, article or device that includes the element.

Steps of a method or an algorithm described in combination with the embodiments disclosed herein may be implemented in hardware, in a software module executed by a processor, or in a combination thereof. The software module may be placed in any other form of storage medium that is well known in the art, such as a random access memory (RAM), a memory, a read-only memory (ROM), an electrically programmable ROM (EPROM), an electrically erasable programmable ROM (EEPROM), a register, a hard disk, a removable magnetic disk, a compact disc read-only memory (CD-ROM), or the like.

The foregoing description of the disclosed embodiments enables a person skilled in the art to implement or use the present disclosure. Various modifications to these embodiments are apparent to a person skilled in the art, and the general principles defined herein may be implemented in other embodiments without departing from the spirit or scope of the present disclosure. Therefore, the present disclosure is not intended to be limited to the embodiments shown herein, but is to be accorded the widest scope consistent with the principles and novel features disclosed herein.

1. A data transmission method based on a cloud network, comprising:
receiving a first data flow transmitted through a first elastic network interface in an elastic network interface pair connected to a first cloud server, wherein the elastic network interface pair comprises the first elastic network interface and a second elastic network interface, the first elastic network interface is connected to the first cloud server, and the first elastic network interface is configured to transmit a data flow to a second cloud server through the second elastic network interface connected to the second cloud server, wherein the elastic network interface pair is independently deployed in a subnet in the cloud network; and
when it is determined that the first data flow is transmitted through the elastic network interface pair, querying an address of the second elastic network interface in a fast channel, and forwarding the first data flow to the second cloud server based on the address of the second elastic network interface.

2. The method according to claim 1, further comprising:
after the elastic network interface pair is connected to the first cloud server and the second cloud server, obtaining an address of the first elastic network interface and the address of the second elastic network interface; and
saving the address of the first elastic network interface and the address of the second elastic network interface in the fast channel.

3. The method according to claim 1, further comprising:
dynamically updating an address of the first elastic network interface or the address of the second elastic network interface in the elastic network interface pair based on a change of a physical machine connected to the elastic network interface pair.

4. The method according to claim 1, wherein an address of the first elastic network interface is configured as a physical machine address of a physical machine in which the first cloud server is located, and the address of the second elastic network interface is configured as a physical machine address of a physical machine in which the second cloud server is located.

5. The method according to claim 1, wherein the forwarding the first data flow to the second cloud server based on the address of the second elastic network interface comprises:
encapsulating the first data flow, wherein an inner layer of the encapsulated first data flow carries a source address, a destination address, a source mac address, and a destination mac address, and an outer layer of the encapsulated first data flow carries a source physical machine address and a destination physical machine address, wherein the source physical machine address is an address of the first elastic network interface, the destination physical machine address is the address of the second elastic network interface, and the source mac address and the destination mac address are mac addresses of the elastic network interface pair; and
sending the encapsulated first data flow to a physical machine corresponding to the destination physical machine address, so that the physical machine corresponding to the destination physical machine address decapsulates the encapsulated first data flow, and sends the decapsulated first data flow to the second cloud server based on the destination mac address.

6. The method according to claim 1, wherein the first elastic network interface is connected to at least one first cloud server, and/or the second elastic network interface is connected to at least one second cloud server.

7. The method according to claim 1, further comprising:
performing a corresponding quality of service strategy for the first data flow.

8. A data transmission device based on a cloud network, comprising a memory, a processor, and a computer program stored in the memory and capable of running on the processor, wherein when the computer program is executed by the processor, the processor is caused to:
receive a first data flow transmitted through a first elastic network interface in an elastic network interface pair connected to a first cloud server, wherein the elastic network interface pair comprises the first elastic network interface and a second elastic network interface, the first elastic network interface is connected to the first cloud server, and the first elastic network interface is configured to transmit a data flow to a second cloud server through the second elastic network interface connected to the second cloud server, wherein the elastic network interface pair is independently deployed in a subnet in the cloud network; and
when it is determined that the first data flow is transmitted through the elastic network interface pair, query an address of the second elastic network interface in a fast channel, and forward the first data flow to the second cloud server based on the address of the second elastic network interface.

9. The data transmission device according to claim 8, wherein the processor is caused to:
after the elastic network interface pair is connected to the first cloud server and the second cloud server, obtain an address of the first elastic network interface and the address of the second elastic network interface; and
save the address of the first elastic network interface and the address of the second elastic network interface in the fast channel.

10. The data transmission device according to claim 8, wherein the processor is caused to:
dynamically update an address of the first elastic network interface or the address of the second elastic network interface in the elastic network interface pair based on a change of a physical machine connected to the elastic network interface pair.

11. The data transmission device according to claim 8, wherein an address of the first elastic network interface is configured as a physical machine address of a physical machine in which the first cloud server is located, and the address of the second elastic network interface is configured as a physical machine address of a physical machine in which the second cloud server is located.

12. The data transmission device according to claim 8, wherein the processor is caused to:
encapsulate the first data flow, wherein an inner layer of the encapsulated first data flow carries a source address, a destination address, a source mac address, and a destination mac address, and an outer layer of the encapsulated first data flow carries a source physical machine address and a destination physical machine address, wherein the source physical machine address is an address of the first elastic network interface, the destination physical machine address is the address of the second elastic network interface, and the source mac address and the destination mac address are mac addresses of the elastic network interface pair; and
send the encapsulated first data flow to a physical machine corresponding to the destination physical machine address, so that the physical machine corresponding to the destination physical machine address decapsulates the encapsulated first data flow, and sends the decapsulated first data flow to the second cloud server based on the destination mac address.

13. The data transmission device according to claim 8, wherein the first elastic network interface is connected to at least one first cloud server, and/or the second elastic network interface is connected to at least one second cloud server.

14. The data transmission device according to claim 8, wherein the processor is caused to:
perform a corresponding quality of service strategy for the first data flow.

15. A non-transitory computer-readable storage medium, wherein the computer-readable storage medium stores instructions, and when the instructions are run on a terminal device, the terminal device is enabled to:
receive a first data flow transmitted through a first elastic network interface in an elastic network interface pair connected to a first cloud server, wherein the elastic network interface pair comprises the first elastic network interface and a second elastic network interface, the first elastic network interface is connected to the first cloud server, and the first elastic network interface is configured to transmit a data flow to a second cloud server through the second elastic network interface connected to the second cloud server, wherein the elastic network interface pair is independently deployed in a subnet in the cloud network; and
when it is determined that the first data flow is transmitted through the elastic network interface pair, query an address of the second elastic network interface in a fast channel, and forward the first data flow to the second cloud server based on the address of the second elastic network interface.

16. The storage medium according to claim 15, wherein the processor is caused to:
after the elastic network interface pair is connected to the first cloud server and the second cloud server, obtain an address of the first elastic network interface and the address of the second elastic network interface; and
save the address of the first elastic network interface and the address of the second elastic network interface in the fast channel.

17. The storage medium according to claim 15, wherein the terminal device is enabled to:
dynamically update an address of the first elastic network interface or the address of the second elastic network interface in the elastic network interface pair based on a change of a physical machine connected to the elastic network interface pair.

18. The storage medium according to claim 15, wherein an address of the first elastic network interface is configured as a physical machine address of a physical machine in which the first cloud server is located, and the address of the second elastic network interface is configured as a physical machine address of a physical machine in which the second cloud server is located.

19. The storage medium according to claim 15, wherein the terminal device is enabled to:
encapsulate the first data flow, wherein an inner layer of the encapsulated first data flow carries a source address, a destination address, a source mac address, and a destination mac address, and an outer layer of the encapsulated first data flow carries a source physical machine address and a destination physical machine address, wherein the source physical machine address is an address of the first elastic network interface, the destination physical machine address is the address of the second elastic network interface, and the source mac address and the destination mac address are mac addresses of the elastic network interface pair; and
send the encapsulated first data flow to a physical machine corresponding to the destination physical machine address, so that the physical machine corresponding to the destination physical machine address decapsulates the encapsulated first data flow, and sends the decapsulated first data flow to the second cloud server based on the destination mac address.

20. The storage medium according to claim 15, wherein the first clastic network interface is connected to at least one first cloud server, and/or the second clastic network interface is connected to at least one second cloud server.
